(19) United States
(12) Patent Application Publication
(10) Pub. No.: US 2011/0166842 A1
(43) Pub. Date: Jul. 7, 2011

(54) LAYER STRIPPING METHOD

(76) Inventors: Erik Jan Banning-Geertsma, Milltimber (GB); Teruhiko Hagiwara, Houston, TX (US); Richard Martin Ostermeier, Houston, TX (US)

(21) Appl. No.: 12/994,224

(22) PCT Filed: May 26, 2009
(86) PCT No.: PCT/US09/45104

§ 371 Date: Jan. 3, 2011

Related U.S. Application Data
(60) Provisional application No. 61/056,301, filed on May 27, 2008.

(51) Int. Cl. G06G 7/48

(52) U.S. Cl. 703/6

(57) ABSTRACT

A layer stripping method that quickly and robustly determines values of undetermined parameters that model a formation (F). The layer stripping method includes applying inversion methods to subsets (d) of measured data (d) and corresponding modeled responses such that the value of a parameter determined during the application of an inversion method to one subset of the data (d) and the corresponding modeled response can be used to reduce the inversion space of a modeled response that corresponds to another subset of the data (d), to which an inversion method is subsequently applied.

### TECHNICAL FIELD

This invention relates generally to inversion methods for fitting a model to data and, more specifically, to methods of determining values of undetermined parameters that model a geophysical environment using data measured in the geophysical environment.

### BACKGROUND

Conventional inversion methods can be applied to response data measured in an actual system or environment (or a modeled system or environment) to determine values of undetermined model parameters. These inversion methods allow interpretation of the data in terms of the values of the undetermined parameters that characterize the environment or system in which the data was taken.

In conventional inversion, the values of the undetermined parameters are determined by mathematically minimizing the difference between a calculated response of a modeled system or environment (known as a forward model calculation) and the response data. Conventional inversion typically requires many forward modeling calculations and is hence processing-intensive and slow. This is especially true where the data include many points and modeled responses include multiple undetermined parameters. More undetermined parameters moreover increase the possibility of non-unique inversion results.

Another example of an inversion method is turbo-boosting (see U.S. Pat. No. 6,098,019 to Hakvoort et al.). In this method, the end-result is reached by executing a limited number of forward modeling steps or iterations. The model parameter values chosen at each iteration depend in a prescribed way on the mismatch between calculated and actual data responses of the previous iteration, and no explicit mathematical minimization procedures are used. Requiring only a limited number of forward modeling steps, turbo-boosting is fast when compared to conventional inversion.

Both conventional inversion as well as turbo-boosting may not converge, and the resulting model may not be the best representative of the actual system or environment. Conventional inversion, in particular, can be very slow for situations in which the response data depends (to a significant degree) on a large number of parameters of which values are undetermined. In this patent application, this number will be denoted as the dimensionality of the data. Moreover, for many situations, the dimensionality of the data may differ from data-point to data-point, and the existing inversion methods do not make use of this fact.

It would be useful to have a method of quickly and robustly determining values of undetermined parameters, particularly in cases where not all data-points have the same dimensionality. For example, when applying the technique of Transient ElectroMagnetics (TEM) in a geosteering scenario, it would be useful to accurately invert TEM measurements that are obtained during drilling so as to be able to form an image of the subsurface around the drill bit. Therefore, a need exists in the industry to address the aforementioned deficiencies and inadequacies.

### SUMMARY

The various embodiments of the present invention overcome the shortcomings of the prior art by providing an inversion method denoted as “layer stripping” that quickly and robustly determines values of undetermined parameters that model a system or environment. The layer stripping method is well suited for data that is measured over time and has dimensionality that changes over time, such as that of deep transient electromagnetic (TEM) measurements. The layer stripping method may also be applied to other systems and environments.

Generally, the layer stripping method can be applied to cases where all points of the response data do not have the same dimensionality, that is, when some subsets of the measured data depend only on subsets of the parameters on which other subsets of the data depend. In such cases, the values of a specific subset of undetermined parameters may be determined by applying an inversion method to an appropriate modeled response and an appropriate subset of the response data. These values can then be used to reduce the dimension of the space spanned by the undetermined model parameters of modeled responses (denoted in this application as the “inversion space”) that correspond to other subsets of the data, resulting in a faster, more robust, and more accurate inversion process.

According to an exemplary embodiment of the disclosure, a method of determining values of at least two parameters that model an earth formation includes operating a measurement device to obtain data representing a measured response of the earth formation and operating a computing unit to process the data. The steps of operating the measurement device can include deploying the measurement device in a borehole formed in the earth formation, inducing a magnetic field in the earth formation using a transmitter, removing the transmitter as a source, and measuring the signals using a receiver. The processing steps include determining at least one point that divides the data into at least two subsets, generating at least two modeled responses that correspond to the at least two subsets, determining an order of applying inversion methods to the at least two subsets and corresponding at least two modeled responses, and applying an inversion method to each of the at least two subsets and corresponding at least two modeled responses in the determined order. The order is determined such that a value of at least one of the at least two model parameters determined through a first application of an inversion method to a first of the at least two subsets and a first of the at least two modeled responses can be used to reduce the dimension of the inversion space (i.e., the space spanned by undetermined model parameters on which a modeled response depends) of a second of the at least two modeled responses preceding a second application of an inversion method to a second of the at least two subsets and the second of the at least two modeled responses.

According to one aspect of the invention, a computer readable medium including computer executable instructions is adapted to perform the exemplary method described above.

In certain embodiments, the magnetic field induced by the transmitter is a static (i.e., DC) field, the measured response is an electromagnetic response measured as a function of time, the at least two subsets correspond to at least two time intervals, and the order is a chronological order. Here, the at least one point that divides the data into at least two subsets corresponds to a so-called boundary time. In these embodiments, the method can further include calculating a value of at least one boundary distance using the value of an electromagnetic parameter determined through a preceding application of an inversion method, wherein the value of the at least one boundary distance can be used to reduce the dimension of the inversion space of a modeled response to which, along with a corresponding data subset, an inversion method is subsequently applied.

In certain embodiments, the measured response is a geophysical log recorded as a function of along-hole-depth, and the at least two subsets correspond to length intervals. Here, the at least one point that divides the data into at least two subsets may correspond to at least one boundary between layers.

In certain embodiments, the inversion method is based on mathematical minimization of a misfit function or cost function using an approximation of a derivative. In other embodiments, the inversion method is based on turbo-boosting. In still other embodiments, alternative inversion methods may be used.

According to an exemplary embodiment of the disclosure, a method of determining values of parameters that model a layered earth formation includes operating a measurement device to obtain data representing a measured response of the layered earth formation and operating a computing unit to process the data. The data is measured, for example, over time and the steps of operating the measurement device can include deploying the measurement device in a borehole formed in the earth formation, inducing a magnetic or an electric or an electromagnetic field in the earth formation using a transmitter, removing the transmitter as a source, and measuring the signals received using a receiver.

The steps of operating the computing unit to process the data can include selecting a first subset of the data that corresponds to a first time interval, generating a first modeled response that is dependent on the resistivity of a first layer of the formation, and applying an inversion method to the first subset of the data and to the first modeled response to determine a first value for the first layer resistivity. Once the first value of the first layer resistivity has been determined, the value is input for the first layer resistivity into the first modeled response to provide a first calculated response. The data and the first calculated response are compared to one another to determine a first boundary time where the data deviates significantly from the first calculated response. A second value of a first boundary distance is determined using the first value of the first layer resistivity and the first boundary time. As the data deviates from the first calculated response, a second subset of the data is selected after the first boundary time. A second modeled response is generated that is dependent on the first layer resistivity, the first boundary distance, and the resistivity of a second layer. The first value is input to the first layer resistivity and the second value is input to the first boundary distance to reduce the inversion space of the second modeled response. An inversion method is applied to the second subset of the data and the corresponding second modeled response to determine a third value for the second layer resistivity. The inputting and comparing steps are repeated to determine a second calculated response. Each time the calculated response deviates from the data, a boundary time is determined, a boundary distance is determined, a subset of the data is selected, a modeled response is generated, the subset of the data and corresponding modeled response are inverted to determine a value of a parameter, the value of the parameter is used to provide a calculated response, and the calculated response is compared to the data.

The comparing step can include calculating a ratio curve using the calculated response and the data; selecting the point in time as a boundary time if the value of the ratio curve at the point in time substantially deviates from a value of one.

The foregoing has broadly outlined some of the aspects and features of the present invention, which should be construed to be merely illustrative of various potential applications of the invention. Other beneficial results can be obtained by applying the disclosed information in a different manner or by combining various aspects of the disclosed embodiments. Accordingly, other aspects and a more comprehensive understanding of the invention may be obtained by referring to the detailed description of the exemplary embodiments taken in conjunction with the accompanying drawings, in addition to the scope of the invention defined by the claims.

### BRIEF DESCRIPTION OF THE DRAWINGS

FIG. 1 is an illustration of a measurement system and a formation, according to an exemplary embodiment of the present disclosure.

FIG. 2 is a partial illustration of a measurement device of the system positioned in the formation of FIG. 1.

FIG. 3 is a graph illustrating response data measured by the measurement device in the formation of FIGS. 1 and 2 and a layer stripping method, according to a first embodiment of the present disclosure.

FIG. 4 is a graph illustrating ratio curves.

FIGS. 5-7 are graphs illustrating response data measured by the measurement device in the formation of FIGS. 1 and 2 and a layer stripping method, according to a second embodiment of the present disclosure.

### DETAILED DESCRIPTION OF THE INVENTION

As required, detailed embodiments of the present invention are disclosed herein. It must be understood that the disclosed embodiments are merely exemplary of the invention that may be embodied in various and alternative forms, and combinations thereof. As used herein, the word “exemplary” is used expansively to refer to embodiments that serve as illustrations, specimens, models, or patterns. The figures are not necessarily to scale and some features may be exaggerated or minimized to show details of particular components. In other instances, well-known components, systems, materials, or methods have not been described in detail in order to avoid obscuring the present invention. Therefore, specific structural and functional details disclosed herein are not to be interpreted as limiting, but merely as a basis for the claims and as a representative basis for teaching one skilled in the art to variously employ the present invention.

The invention is taught in the context of methods that are used to determine values of parameters that fit a model of an environment or system to data that is measured in the actual environment or system. The inversion method that is incorporated into the layer stripping method may be conventional inversion, turbo boosting, combinations thereof, and alternatives thereto. Conventional inversion often utilizes a minimization technique to aid in determining values of model parameters that minimize the difference between a calculated response of the modeled environment and a measured response of the actual environment. Turbo-boosting, in one possible application, iterates estimated values of model parameters a fixed number of times without actively minimizing a mismatch between calculated and measured response.

As used herein, the term “modeled response” will refer to a function of undetermined model parameters that is used to calculate the response of a system or environment. Certain of the undetermined parameters characterize the environment, and the function may be analytical, incorporated in a computer program, etc. The term “calculated response” will refer to a calculation of the response of the modeled system where estimated or determined values of the model parameters are input into the modeled response. The term “measured response” refers to data measured in the actual environment. It should be understood that where the calculated response fits the measured response, the parameter values may be used to characterize the actual system or environment in which the data is measured.

For reference, terms that relate the measured data and the modeled response are now described. As mentioned earlier, the number of parameters of an actual environment that significantly affect a measured response is termed the dimensionality of the data. The parameters that are presumed to significantly affect a measured response are generally those that are used in a well-chosen modeled response. Certain, if not all, of these parameters are undetermined. The number of yet undetermined parameters of a modeled response is termed the inversion space of that modeled response. For well-chosen models, the dimension of the inversion space of the modeled response is less than or equal to the dimensionality of the data. If this were not the case, an inversion method would attempt to find optimum values for parameters that do not actually significantly affect the corresponding data, implying that the model is not a good representation of the actual system.

According to conventional inversion methods, a single modeled response of the entire environment and all the measured data are used to simultaneously determine values for all the undetermined parameters. That is to say, conventional inversion methods use an inversion space of which the dimension is equal to the largest or collective dimensionality of all of the measured data-points. For cases where a first subset of the data has smaller dimensionality than a second subset of the data, such conventional inversion methods are hence not optimal since, for this first subset of the data, unnecessary computing cycles would be spent on trying to find values for undetermined parameters in the inversion space that do in fact not affect this first subset of the data.

The data is measured as function of a parameter that is incremented or changes as the data is measured. For example, the incremented parameter can be time or position. For purposes of teaching, the data will be described as being measured as a function of time.

For certain data measurements, the dimensionality of the data can change over time. The data collected at one point in time may have a different dimensionality than data collected at another point in time. Such data can collectively have a high dimensionality that is equal to the subset of the data with the highest dimensionality although other subsets of the data have a lower dimensionality. Such data is not effectively fit with conventional inversion methods but can be efficiently and robustly fit with a layer stripping method, according to the present disclosure.

Generally described, a first exemplary layer stripping method applies a series of inversion methods to the measured data subset by subset, and uses the parameter values determined through preceding applications of inversion methods to reduce the inversion spaces of modeled responses to which inversion methods are subsequently applied. Inversion methods are typically applied to the subsets of the measured data in order of increasing dimensionality since the lowest dimensionality subsets correspond to modeled responses that have smaller inversion spaces (i.e., inversion spaces of lower dimension) that do not first have to be reduced to be efficiently and robustly fit. Alternatively described, the layer stripping method includes dividing the data into subsets and applying an inversion method to the subsets in a selected order such that the inversion spaces of modeled responses that correspond to certain of the subsets are reduced before the inversion methods are applied. The order can be selected such that the dimension of the inversion spaces of the modeled responses are minimized. The relatively high speed of the application of each inversion method is facilitated by the reduced inversion space.

### Formation

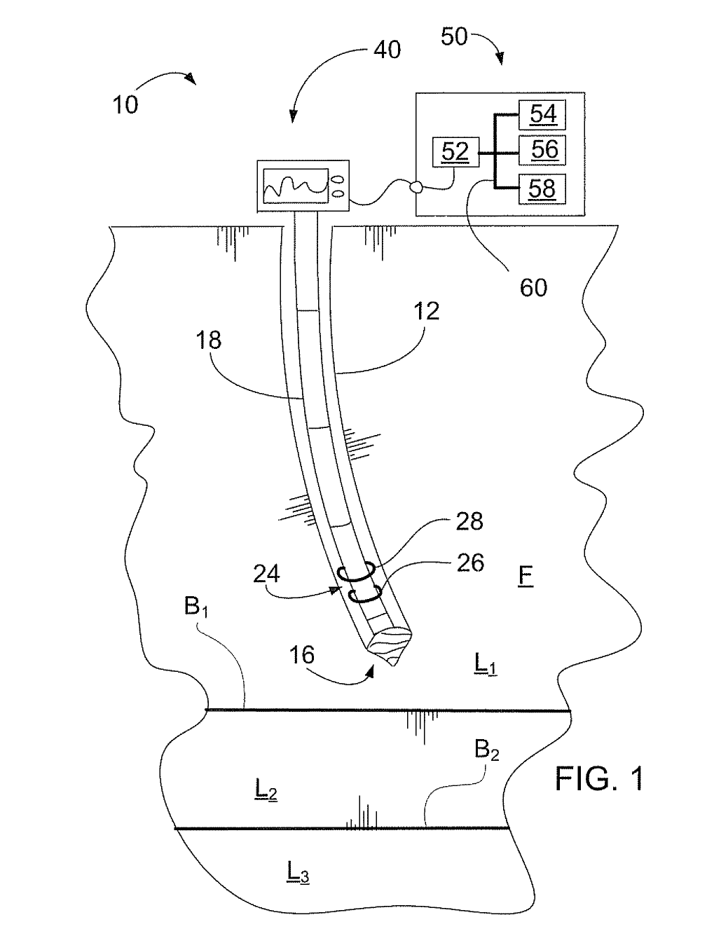

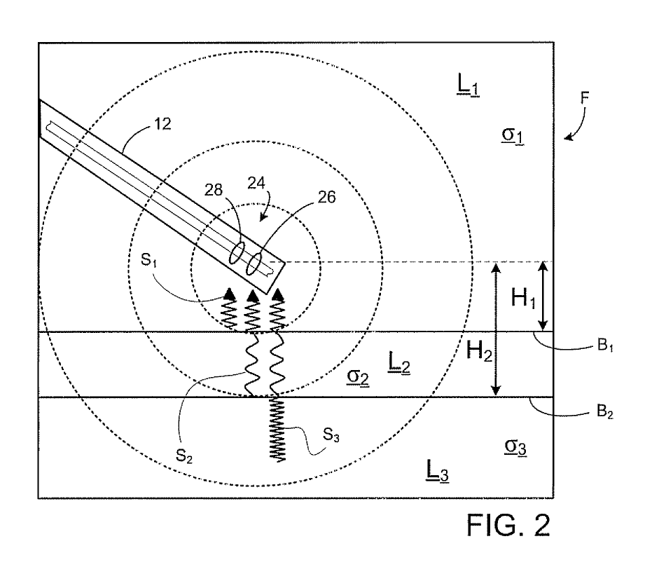

Referring to FIGS. 1-3, for purposes of teaching, an exemplary layer stripping method is now applied to transient electromagnetic (TEM) data d that represents the measured response of an exemplary formation F. Referring to FIGS. 1 and 2, formation F has three layers L₁, L₂, L₃, each having a different conductivity σ₁, σ₂, σ₃. It should be understood that layers L₁, L₂, L₃ could be characterized by other parameters, for example, resistivity instead of conductivity. It should also be understood that, in this example, other electromagnetic parameters of the various layers (such as magnetic permeability, electrical permittivity, etc.) are assumed to have values equal to those of vacuum. There is a first boundary B₁ between first layer L₁ and second layer L₂ and a second boundary B₂ between second layer L₂ and third layer L₃.

### Measurement System

Referring to FIG. 1, a measurement system 10 is configured to drill a borehole 12 in formation F and to take measurements while drilling (MWD). In alternative embodiments, borehole 12 is drilled, the drill is removed, and a measurement device is then lowered into the borehole by a cable or other suitable suspension means.

To drill borehole 12, a drill bit 16 is positioned at the end of a series of tubular elements, referred to as a drill string 18. Drill bit 16 can be directed by a steering system, such as a rotatable steering system or a sliding steering system. In certain applications, measurements facilitate directing drill bit 16, for example, toward a hydrocarbon fluid reservoir.

Measurement system 10 includes a measurement device 24 that is generally described as an array of transmitters and receivers and a corresponding support structure. Here, measurement device 24 includes a transmitter 26 and a receiver 28. Referring to FIG. 2, measurement device 24 is positioned in borehole 12 in first layer L₁ of formation F, at a first distance H₁ from first boundary B₁, and at a second distance H₂ from second boundary B₂.

In the exemplary embodiment, each of transmitter 26 and receiver 28 includes a coil antenna. Transmitter 26 and receiver 28 are arranged to be substantially coaxial. This arrangement is used for purposes of teaching. However, in alternative embodiments, transmitters and/or receivers can be those other than coil-antennas, and/or multi-axial so as to send and receive signals along multiple axes.

Measurement system 10 further includes a data acquisition unit 40 and a computing unit 50. Data acquisition unit 40 controls the output of transmitter 26 and collects the response at receiver 28. The response and/or data representative thereof are provided to computing unit 50 to be processed Computing unit 50 includes computer components including a data acquisition unit interface 52, an operator interface 54, a processor unit 56, a memory 58 for storing information, and a bus 60 that couples various system components including memory 58 to processor unit 56.

Computing unit 50 can be positioned at the surface or at a remote location such that information collected by measurement device 24 while in borehole 12 is readily available. For example, a telemetry system can connect measurement device 24, data acquisition unit 40, and computing unit 50. In alternative embodiments, data acquisition unit 40 and/or computing unit 50 is combined with or integral to measurement device 24 and processes signals while in borehole 12.

### Method of Measuring Transient Electromagnetic Response

An exemplary method of measuring a transient electromagnetic (TEM) response of formation F with measurement device 24 is now described. A TEM response is useful, for example, in deep reading electromagnetic (DEM) well logging applications to identify the boundaries and properties of layers of formation F at relatively large distances from borehole 12. TEM measurements can be made with measurement device 24 by inducing a static or DC magnetic field with transmitter 26, removing transmitter 26 as a source, and measuring the electromagnetic signals arriving at receiver 28 from regions of formation F. As previously mentioned, here, response data d is measured as a function of time. In alternative embodiments, the magnetic field may be non-static or non-DC.

By measuring response data d over time, data d is physically related to formation F. Different subsets d₁, d₂, d₃ of data d inherently include information about regions of formation F of different extent. For example, early subset d₁ represents signals received from regions of formation F that are close to measurement device 24 whereas late subset d₃ represents signals that have also traveled through regions of formation F that are farther away from measurement device 24. As described in further detail below, this physical relation facilitates selection of an order in which an inversion method is applied to subsets d₁, d₂, d₃ of data d.

### Modeling Subsets of Data

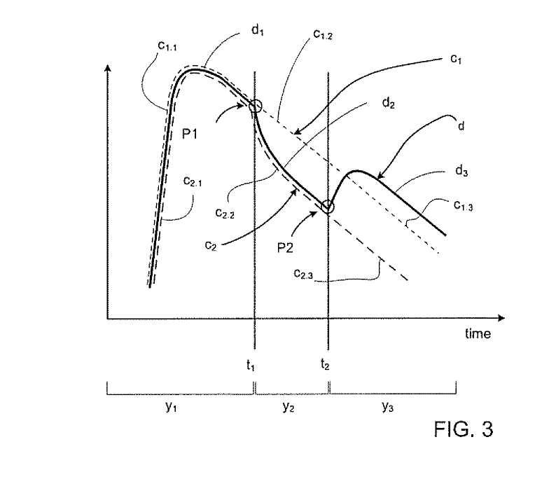

Referring to FIGS. 2 and 3, since formation F has multiple layers L₁, L₂, L₃, the dimensionality of data d is related to time. Specifically, the dimensionality of subsets of data d will increase over time. The relationship of data d to formation F is now described in further detail.

At early time y₁, a formation response signal S₁ received by receiver 28 has only traveled through first layer L₁ in which measurement device 24 is located. Formation response signal S₁ for early time y₁ therefore is influenced by first layer conductivity σ₁, but is uninfluenced by properties of layers L₂ and L₃. Accordingly, early subset d₁ has a dimensionality of one and can be modeled as the response of a homogeneous formation.

At intermediate time y₂, a formation response signal S₂ will have traveled through first and second layers L₁, L₂ and will be influenced by first and second layer conductivities σ₁, σ₂ as well as first boundary distance H₁. Intermediate subset d₂ has a dimensionality of three and can be modeled as the response of a two layer formation. In this example, the modeled response of a two layer formation can successfully be used to fit both early subset d₁ and intermediate subset d₂.

At late time y₃, a formation response signal S₃ will have traveled through all three layers L₁, L₂, L₃ and will be influenced by first, second, and third layer conductivities σ₁, σ₂, σ₃ as well as first and second boundary distances H₁, H₂. Late subset d₃ has a dimensionality of five and can be modeled as the response of a three layer formation. In this example, the modeled response of a three layer formation can successfully be used to fit all of data d and represents the response of formation F. Were formation F to have additional layers, the dimensionality of the data would increase for each additional layer and the modeled response would correspond thereto.

Dividing Data into Subsets

To quantitatively parse or divide data d into subsets d₁, d₂, d₃ that correspond to early time y₁, intermediate time y₂, and late time y₃, the following method can be used. Measured data d has characteristics that can be used to identify the number of layers L₁, L₂, L₃ and number of boundaries B₁, B₂ of formation F. For example, since the response of a homogeneous formation decays at a generally constant slope for later time (when plotted on a double-logarithmic graph), deviations and shifts from a constant slope indicate the presence of boundaries B₁, B₂ and layers L₁, L₂, L₃. Referring to FIG. 3, a first inflection point P₁ in data d at a boundary time t₁ indicates the presence of second layer L₂ and a second inflection point P₂ in data d at boundary time t₂ indicates the presence of third layer L₃.

One method of determining points P₁, P₂ is to select boundary times t₁, t₂ on the basis of changes from a constant value of the slope of the curve representing data d on a double logarithmic scale. Early time y₁ can be selected as time interval t<t₁, intermediate time y₂ can be selected as time interval t₁<t<t₂, and late time y₃ can be selected as time interval t>t₂. Here, early subset d₁ is data d for early time y₁, intermediate subset d₂ is data d for intermediate time y₂, and late subset d₃ is data d for late time y₃. A method of determining points P₁, P₂ using ratio curves x is described in further detail below. The ratio curves method can also be used to adjust or update points P₁, P₂ that are found using the previous method.

### Application of a First Layer Stripping Method

Referring to FIG. 3, since the dimensionality of data d increases at boundary time t₁ and again at boundary time t₂, a first step of the layer stripping method is applying an inversion method to early subset d₁. A first modeled response m₁ of early subset d₁ is generated which is that of a homogeneous formation having first layer conductivity σ₁. Since the dimension of the inversion space of first modeled response m₁ is one, applying an inversion method to early subset d₁ and first modeled response m₁ can quickly and robustly determine or estimate a value v₁ of first layer conductivity σ₁. As shown in FIG. 3, a first calculated response c₁ fits data d in early time y₁, but does not fit data d in late or intermediate time y₂, y₃. In other words, a subset c_{1,1} of first calculated response c₁ fits early subset d₁ of data d, but, in this case, subsets c_{1,2}, c_{1,3} of first response c₁ do not fit intermediate subset d₂ or late subset d₃. First calculated response c₁ is first modeled response m₁ with value v₁ used for first layer conductivity σ₁ and is calculated over all times y₁, y₂, y₃.

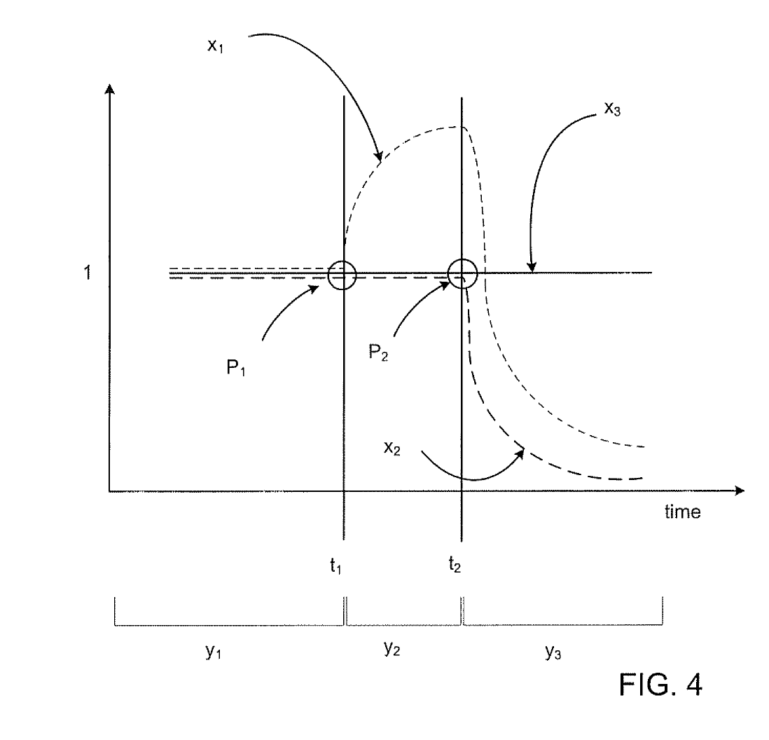

Referring momentarily to FIG. 4, a graph of ratio curves x includes a first ratio curve x₁ that is equal to the ratio of first calculated response c₁ and data d plotted over time. Each ratio curve x is substantially equal to a value of one where a calculated response c fits data d and deviates from a value of one where a calculated response c does not fit data d. Points P₁, P₂ can be determined at points where ratio curves x substantially deviate from a value of one. Accordingly, an updated value of boundary time t₁ can be determined using ratio curve x₁.

Value v₁ of first layer conductivity σ₁ can then be used to estimate a value v₂ for first boundary distance H₁ from boundary time t₁, using an appropriate inversion method. This inversion method may make use of an equation resembling H₁²=0.5*8*t₁/(σ₁*μ₀), where μ₀ indicates the magnetic permeability of L₁, but may also rely on numerical techniques. In subsequent applications of inversion methods, values v₁, v₂ of parameters σ₁, H₁ can be input into subsequent modeled responses that include parameters σ₁, H₁, for example to reduce the dimension of the inversion space of modeled responses m₂, m₃ that correspond to data subsets d₂, d₃.

According to the exemplary layer stripping method, a second step is applying an inversion method to intermediate subset d₂. A second modeled response m₂ is generated that relates to intermediate subset d₂. Second modeled response m₂ is that of a two layer formation and hence depends on first layer conductivity σ₁, first boundary distance H₁, and second layer conductivity σ₂. Without any additional knowledge, the dimension of the inversion space of d₂ would therefore be equal to three.

Initially, the dimension of the inversion space of second modeled response m₂ is equal to the dimensionality of intermediate subset d₂. However, since values v₁, v₂ of first layer conductivity σ₁ and first boundary distance H₁ have been determined through the first step of the layer stripping method, the dimension of the inversion space of second modeled response m₂ is reduced to one, being spanned only by the second layer conductivity σ₂. Consequently, the dimension of the resulting inversion space of second modeled response m₂ is less than the dimensionality of intermediate subset d₂. The reduced dimension of the inversion space thus allows an inversion method to be efficiently and robustly applied to second modeled response m₂ and intermediate subset d₂ to determine a value v₃ of second layer conductivity σ₂. A second calculated response c₂ is second modeled response m₂ with value v₁ input to first layer conductivity σ₁, value v₂ input to first boundary distance H₁, and value v₃ input to second layer conductivity σ₂ and is calculated over all times y₁, y₂, y₃. Referring to FIG. 3, a subset c_{2,1} of calculated response c₂ fits early subset d₁ and a subset c_{2,2} of calculated response c₂ fits intermediate subset d₂, but, in this case, a subset c_{2,3} of calculated response c₂ does not fit late subset d₃. Referring to FIG. 4, as described above, an updated value of boundary time t₂ can be determined using ratio curve x₂, which is equal to the ratio of second calculated response c₂ and data d plotted over times y₁, y₂, y₃.

A value v₄ of second boundary distance H₂ can be determined by appropriate conventional or other inversion methods, as value v₁ of first layer conductivity σ₁, value v₂ of first boundary distance H₁, value v₃ of second layer conductivity σ₂, and second boundary time t₂ are known. For example, use can be made of an equation resembling H₁₂²=0.5*8*t₂/(σ₁₂^{N12}*σ₂₁^{(1-N12)}*μ₀) where N12≅0.0351, σ₁₂ is the smaller of σ₁ and σ₂, σ₂₁ is the larger of σ₁ and σ₂, H₁₂=cos(a)*H₁−sin(a)*H₂, and a≅0.55* arctan(2*log(σ₁/σ₂))+270.

A third step of the layer stripping method is the application of an inversion method to late subset d₃. A third modeled response m₃ is generated that relates to late subset d₃. Third modeled response m₃ is that of a three layer formation and hence depends on five parameters, namely first layer conductivity σ₁, first boundary distance H₁, second layer conductivity σ₂, second boundary distance H₂, and third layer conductivity σ₃.

Without any prior knowledge of σ₁, σ₂, σ₃, H₁ and H₂, the dimension of the inversion space of third modeled response m₃ is equal to the dimensionality of late subset d₃, i.e., it is equal to five. However, since value v₁ of first layer conductivity σ₁ and value v₂ of first boundary distance H₁ have been determined through the first step of the layer stripping method, and value v₃ of second layer conductivity σ₂ and value v₄ of second boundary distance H₂ have been determined through the second step of the layer stripping method, the inversion space of third modeled response m₃ is reduced to a one dimensional space spanned by third layer conductivity σ₃.

Consequently, the dimension of the resulting inversion space of third modeled response m₃ is much less than the dimensionality of late subset d₃. This allows an inversion method to be efficiently and robustly applied to third modeled response m₃ and late subset d₃ to determine a value v₅ of third layer conductivity σ₃. Third calculated response c₃ is third modeled response m₃ with values v₁, v₂, v₃, v₄, v₅ input to parameters σ₁, H₁, σ₂, H₂, σ₃.

Referring to FIGS. 3 and 4, a subset c_{3,1} of calculated response c₃ fits early subset d₁, a subset c_{3,2} of calculated response c₃ fits intermediate subset d₂, and a subset c_{3,2} of calculated response c₃ fits late subset d₃. Since calculated response c₃ fits data d for all times y₁, y₂, y₃, ratio curve x₃ is equal to one for all times y₁, y₂, y₃. As described above, ratio curve x₃ is the ratio of third calculated response c₃ and data d plotted over times y₁, y₂, y₃.

Values v₁, v₂, v₃, v₅ of parameters σ₁, H₁, σ₂, H₂, σ₃ found at each step of the layer stripping method characterize formation F.

Although the layer stripping method is illustrated with respect to three layer formation F, the layer stripping method is equally applicable to alternative formations and other environments.

### Application of a Second Layer Stripping Method

In contrast to the first exemplary layer stripping method described above, data d need not be clearly divided into distinct subsets with related modeled responses at the outset. For example, boundary times t₁, t₂ may be difficult to discern with the above described method. Accordingly, modeled responses m₁, m₂, m₃ corresponding to different subsets d₁, d₂, d₃ of the data d are not known at the outset.

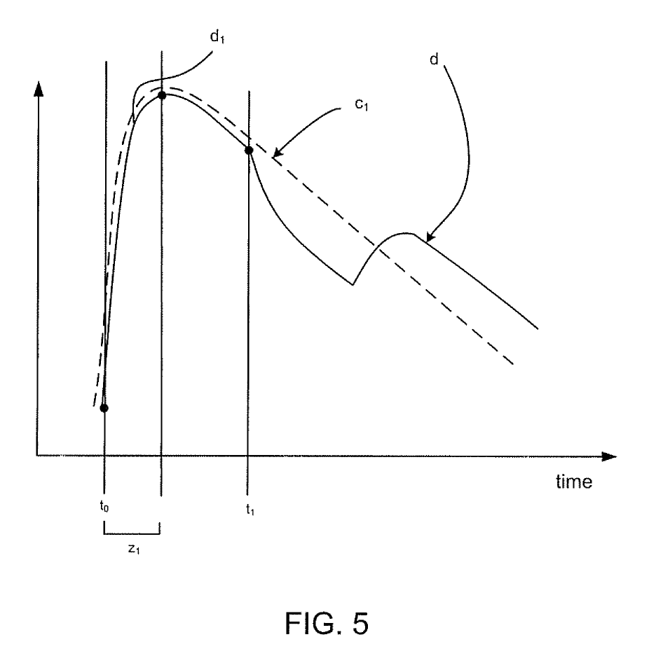

In such instances, referring to FIGS. 5-7, a second exemplary layer stripping method can be used. Referring to FIG. 5, the second exemplary layer stripping method begins by selecting first subset d₁ and generating first modeled response m₁. For example, first subset d₁ is a series of data points that correspond to a time interval z₁ that starts with time t₀. First subset d₁ may be selected to provide a suitable number of data points for applying an inversion method and is minimized so as to reduce the risk of having data points of different dimensionality.

First modeled response m₁ is that of a homogeneous formation, as described above. Value v₁ of first layer conductivity σ₁ can be determined as described above by applying an inversion method to first subset d₁ and first modeled response m₁. The second exemplary layer stripping method continues as first calculated response c₁ is compared to measured data d, where it is understood that calculated response c₁ was chosen so as to substantially fit measured data d at least within time interval z₁. As above, boundary time t₁ is determined where first ratio curve x₁ deviates from a value of one by a selected threshold value. The deviation of first ratio curve x₁ from a value of one indicates the presence of second layer L₂. Boundary time t₁ can be used, along with value v₁ of first layer conductivity σ₁, to determine value v₂ of first boundary distance H₁ as described above.

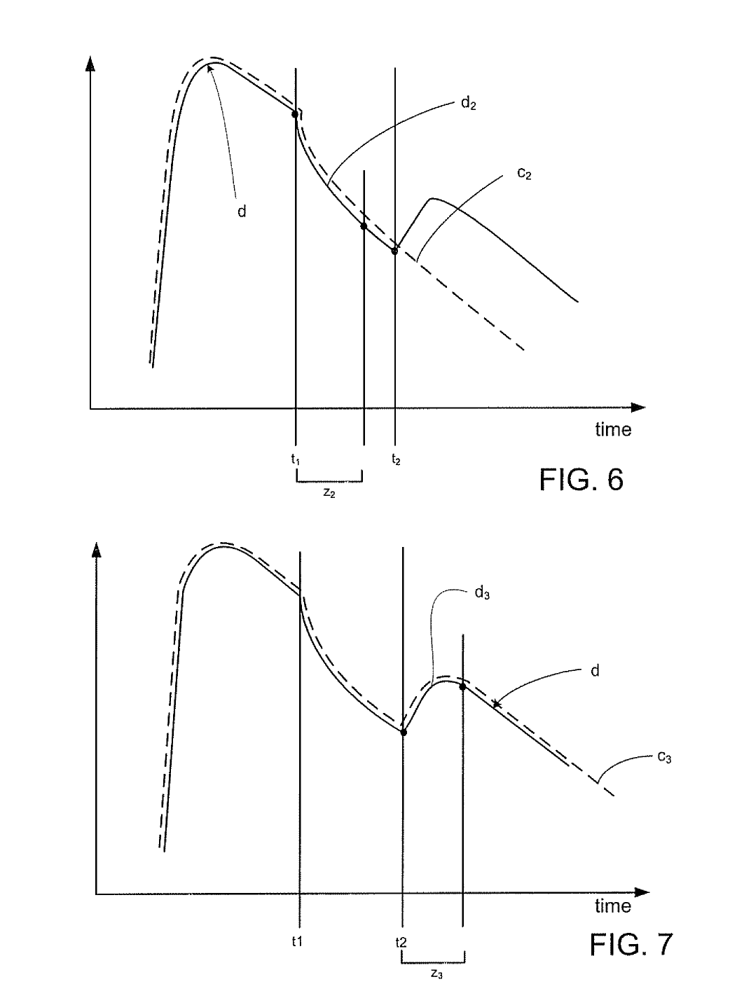

Once it is determined that first ratio curve x₁ deviates from a value of one, a second modeled response m₂ is generated. In general, each time a ratio curve substantially deviates from a value of one, the updated modeled response is that of a formation with an additional layer. Accordingly, second modeled response m₂ is selected to be that of a two layer formation. Also, referring to FIG. 6, second subset d₂ is selected, for example, as a series of data points that correspond to a time interval z₂ beginning with boundary time t₁. Value v₃ of second layer conductivity σ₂ can be determined as described above by applying an inversion method to second subset d₂ and modeled response m₂.

The second exemplary layer stripping method continues as second calculated response c₂, made to substantially fit measured data d up to largest time in interval z₂, is compared to measured data d. As described above, boundary time t₂ is determined at a time where ratio curve x₂ substantially deviates from a value of one by a selected threshold value. The deviation of ratio curve x₂ from a value of one indicates the presence of third layer L₃. Boundary time t₂ can be used, along with value v₁ of first layer conductivity σ₁, value v₂ of first boundary distance H₁, and value v₃ of second layer conductivity σ₂, to determine value v₄ of second boundary distance H₂, as described above.

Since ratio curve x₂ deviates from a value of one, third modeled response m₃ is generated to update second modeled response m₂. Third modeled response m₃ is that of a three layer formation. Referring to FIG. 7, third subset d₃ is selected, for example, as a series of data points that correspond to a time interval z₃ beginning with boundary time t₂. Value v₅ of third layer conductivity σ₃ can be determined as described above by applying an inversion method to third subset z₃ and third modeled response m₃.

Third calculated response c₃, made to substantially fit measured data d up to the largest time in interval z₃, is compared to measured data d. In this example, a third ratio curve x₃ does not substantially deviate from a value of one in the time-range of interest.

Values of certain parameters that have been found through the application of inversion methods or through calculation can be allowed to adjust with the application of an inversion method. In general, the earlier found values should not change dramatically but should rather be fine tuned.

The layer stripping methods of the present disclosure are useful in a variety of applications. For example, the layer stripping method may be applied to acoustic bond logging applications to evaluate multiple cement jobs during a single logging run or to increasing dimensionality logs that measure the inflow into a well along a specific flow path that intersects regions of different permeability.

The above-described embodiments are merely exemplary illustrations of implementations set forth for a clear understanding of the principles of the invention. Variations, modifications, and combinations may be made to the above-described embodiments without departing from the scope of the claims. All such variations, modifications, and combinations are included herein by the scope of this disclosure and the following claims.

1. A method of determining values of at least two parameters that model an earth formation, comprising:
operating a measurement device to obtain data representing a measured response of the earth formation; and
operating a computing unit to process the data, wherein operating the computing unit comprises:
selecting at least two subsets of the data;
generating at least two modeled responses that correspond to the at least two data subsets;
determining an order of applying inversion methods to the at least two data subsets and corresponding at least two modeled responses, the order being determined such that a value of at least one of the at least two parameters determined through a first application of an inversion method to a first of the at least two data subsets and a first one of the at least two modeled responses can be used to reduce the dimension of the inversion space of a second of the at least two modeled responses preceding a second application of an inversion method to the second of the at least two modeled responses and a second of the at least two data subsets; and
applying an inversion method to each of the at least two data subsets and corresponding ones of the at least two modeled responses in the determined order.

2. The method of claim 1, wherein the at least two data subsets are selected by determining at least one point where the data is divided.

3. The method of claim 1, wherein the inversion method comprises a minimization step that includes approximating a derivative.

4. The method of claim 1, wherein the inversion method is based on turbo-boosting.

5. The method of claim 1, wherein the step of operating the measurement device comprises:
deploying the measurement device in a borehole formed in the earth formation;
inducing one of a magnetic field, an electric field, and an electromagnetic field in the earth formation using a transmitter;
removing the transmitter as a source; and
measuring the signals received using a receiver.

6. The method of claim 1, wherein the measured response is an electromagnetic response measured as a function of time, the at least two data subsets correspond to at least two time intervals, and the order is a chronological order.

7. The method of claim 6, wherein the at least two data subsets are selected by determining at least one point where the data is divided.

8. The method of claim 7, wherein the at least one point corresponds to at least one boundary time.

9. The method of claim 1, wherein the measured response is a geophysical log and the at least two data subsets correspond to length intervals.

10. The method of claim 9, wherein the at least two data subsets are selected by determining at least one point where the data is divided.

11. The method of claim 10, wherein the at least one point corresponds to at least one boundary between layers.

12. The method of claim 1, wherein the inversion method is applied to one of the at least two data subsets and corresponding one of the at least two modeled responses to determine a value of at least one of the at least two parameters, wherein a calculated response is generated by inputting the value of at least one of the at least two parameters into the corresponding one of the at least two modeled responses, and wherein the calculated response is compared to the data.

13. The method of claim 12, wherein comparing the calculated response to the data comprises calculating a ratio curve.

14. A computer readable medium comprising computer executable instructions adapted to perform the method of claim 1.

15. A method of determining values of at least two parameters that model an earth formation, comprising:
operating a measurement device to obtain data representing a measured response of the earth formation, wherein the data is measured over time; and
operating a computing unit to process the data, comprising:
selecting a first subset of the data that corresponds to a first time interval;
generating a first modeled response that is dependent on the resistivity of a first layer of the formation;
applying an inversion method to the first subset of the data and the first modeled response to determine a first value for the resistivity of the first layer;
first inputting the first value into the first modeled response to provide a first calculated response;
comparing the data to the first calculated response;
determining a first boundary time where the data substantially deviates from the first calculated response;
calculating a second value of a first boundary distance using the first value and the first boundary time;
selecting a second subset of the data;
generating a second modeled response that is dependent on the resistivity of the first layer, the first boundary distance, and the resistivity of a second layer;
second inputting the first value and the second value into the second modeled response; and
applying an inversion method to the second subset of the data and the corresponding second modeled response to determine a third value for the second layer resistivity.

16. A method for forming an image of a subsurface region, the method comprising:
a) determining values of at least two parameters that model an earth formation, comprising:
a(i) operating a measurement device to obtain data representing a measured response of the earth formation, said operating comprising:
a(i)(1) deploying the measurement device in a borehole formed in the earth formation;
a(i)(2) inducing one of a magnetic field, an electric field, and an electromagnetic field in the earth formation using a transmitter;
a(i)(3) removing the transmitter as a source; and
a(i)(4) measuring the signals received using a receiver; and
a(ii) operating a computing unit to process the data, wherein operating the computing unit comprises:
a(ii)(1) selecting at least two subsets of the data;
a(ii)(2) generating at least two modeled responses that correspond to the at least two data subsets;
a(ii)(3) determining an order of applying inversion methods to the at least two data subsets and corresponding at least two modeled responses, the order being determined such that a value of at least one of the at least two parameters determined through a first application of an inversion method to a first of the at least two data subsets and a first one of the at least two modeled responses can be used to reduce the dimension of the inversion space of a second of the at least two modeled responses preceding a second application of an inversion method to the second of the at least two modeled responses and a second of the at least two data subsets; and
a(ii)(4) applying an inversion method to each of the at least two data subsets and corresponding ones of the at least two modeled responses in the determined order;
b) using the values determined in step a) to invert a set of transient electromagnetic signals that are indicative of information about the subsurface region.

17. The method of claim 16, wherein the at least two data subsets are selected by determining at least one point where the data is divided.

18. The method of claim 16, wherein the inversion method comprises a minimization step that includes approximating a derivative.

19. The method of claim 16, wherein the inversion method is based on turbo-boosting.

20. The method of claim 16, wherein the measured response is an electromagnetic response measured as a function of time, the at least two data subsets correspond to at least two time intervals, and the order is a chronological order.
